(19) United States
(12) Patent Application Publication
(10) Pub. No.: US 2014/0062832 A1
(43) Pub. Date: Mar. 6, 2014

(54) ANTENNA SUPPORT, ANTENNA DEVICE AND ANTENNA SUPPORT ASSEMBLY INCLUDING THE SAME

(71) Applicant: Wistron NeWeb Corp., Hsinchu (TW)

(72) Inventors: Chien-Ming PENG, Hsinchu (TW); Yan-Da CHEN, Hsinchu (TW)

(73) Assignee: Wistron NeWeb Corp., Hsinchu (TW)

(21) Appl. No.: 14/018,177

(22) Filed: Sep. 4, 2013

(30) Foreign Application Priority Data
Sep. 4, 2012 (TW) 101132209

(51) Int. Cl. H01Q 1/12

(52) U.S. Cl. CPC H01Q 1/12; H01Q 1/1235
USPC 343/880; 343/890

(57) ABSTRACT

An antenna support, an antenna device and an antenna support assembly including the same are provided. The antenna support includes a tube-shaped support and at least one antenna fixing unit. The antenna fixing unit is disposed on the outer wall of the tube-shaped support for fixing an antenna unit. The antenna device includes the antenna unit and the antenna support. The antenna support assembly includes a plurality of antenna supports connected to each other at their ends.

### BACKGROUND OF THE INVENTION

1. Field of the Invention

This invention generally relates to an antenna support for supporting an antenna unit.

2. Description of the Prior Art

Following with the progress of electronic technology, a variety of portable electronic devices are widely used in our daily life. For connecting the portable electronic devices to the network and increasing the transmitting/receiving ability to provide better communication quality, the type and design of an antenna of a network access point have been gradually emphasized.

The size, number, and arrangement of the antenna could be varied in order to bring its transmitting/receiving ability into full play. However, as shown in FIG. 1A, one kind of antenna unit 20 is often supported by a specific type of antenna support 80. A different kind of antenna unit 20′ as shown in FIG. 1B usually requires a re-designed antenna support 80′. In other words, the conventional antenna support 20 is hardly applied to various designs of antenna units and the combination thereof.

### SUMMARY OF THE INVENTION

It is an object of the present invention to provide an antenna support for supporting various designs of antenna units and the combination thereof.

It is another object of the present invention to provide an antenna device having more design combinations.

It is another object of the present invention to provide an antenna support assembly having better expanding ability.

The antenna support of the present invention is for supporting an antenna unit. The antenna support includes a tube-shaped support and at least one antenna fixing unit disposed on the outer wall of the tube-shaped support for fixing the antenna unit.

The antenna unit has an antenna plate and a wire coupled to the antenna plate. The wire is disposed in the inner space of the tube-shaped support. The antenna plate is fixed by the antenna fixing unit. The antenna fixing unit has an antenna fixing part for fixing the antenna unit on the antenna fixing unit. The antenna unit is parallel to the axis of the tube-shaped support and is substantially perpendicular to the outer wall of the tube-shaped support when the antenna unit is fixed by the antenna fixing unit.

The antenna fixing unit is a plate parallel to the axis of the tube-shaped support and extending outward from the outer wall of the tube-shaped support. The antenna fixing units are disposed in pairs on opposite sides of the outer wall of the tube-shaped support with respect to the axis of the tube-shaped support. The tube-shaped support further includes an engagement part disposed on an end of the tube-shaped support for engaging with the tube-shaped support of another antenna support.

The antenna device of the present invention includes an antenna unit and an antenna support described above. The antenna device further includes a circuit board disposed at one and of the tube-shaped support, wherein the end of the tube-shaped support has a circuit board engagement part for fixing the circuit board.

The antenna support assembly of the present invention is for supporting a first antenna unit and a second antenna unit. The antenna support assembly includes a first antenna support and a second antenna support. The first antenna support includes a first tube-shaped support and at least one first antenna fixing unit disposed on the outer wall of the first tube-shaped support for fixing the first antenna unit. The second antenna support includes a second tube-shaped support and at least one second antenna fixing unit disposed on the outer wall of the second tube-shaped support for fixing the second antenna unit, wherein one end of the second tube-shaped support engages with one end of the first tube-shaped support.

The first antenna unit has a first antenna plate and a first wire coupled to the first antenna plate. The second antenna unit has a second antenna plate and a second wire coupled to the second antenna plate. The first wire is disposed in the inner space of the first tube-shaped support. The first antenna plate is fixed by the first antenna fixing unit. The second wire is disposed in the inner space of the second tube-shaped support. The second antenna plate is fixed by the second antenna fixing unit. The first tube-shaped support further includes a first engagement part disposed on one end of the first tube-shaped support; the second tube-shaped support further includes a second engagement part disposed on one end of the second tube-shaped support; the first engagement part and the second engagement part engage with each other. The first antenna support and the second antenna support could be identical or different.

### BRIEF DESCRIPTION OF THE DRAWINGS

FIGS. 1A and 1B are schematic views of prior arts;

FIGS. 2A to 2C are schematic views of the preferred embodiment of the antenna support of the present invention;

FIG. 3 is a schematic view of a different embodiment of the present invention;

FIGS. 4A and 4B are schematic views of embodiments of the antenna support assembly of the present invention;

FIG. 5 is a schematic view of a different embodiment of the antenna support assembly of the present invention; and

FIG. 6 is a schematic view of an embodiment of the antenna support of the present invention having a circuit board.

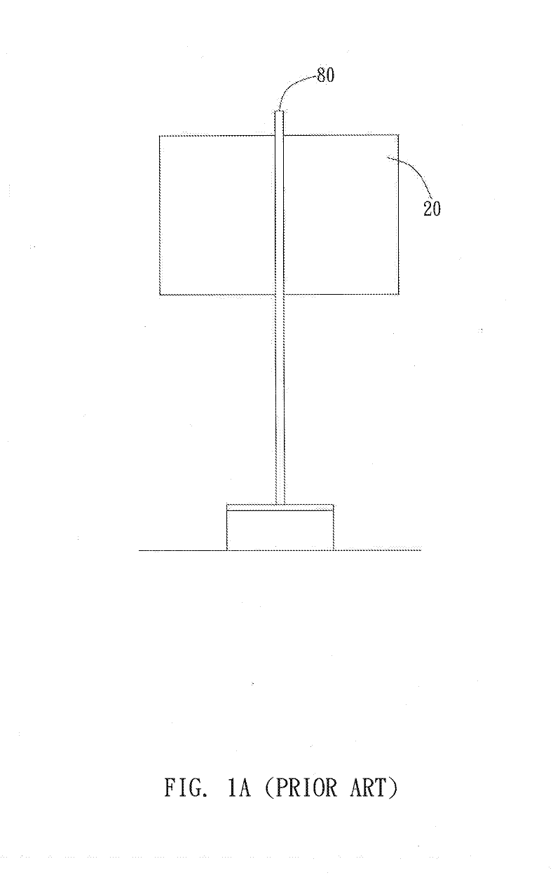

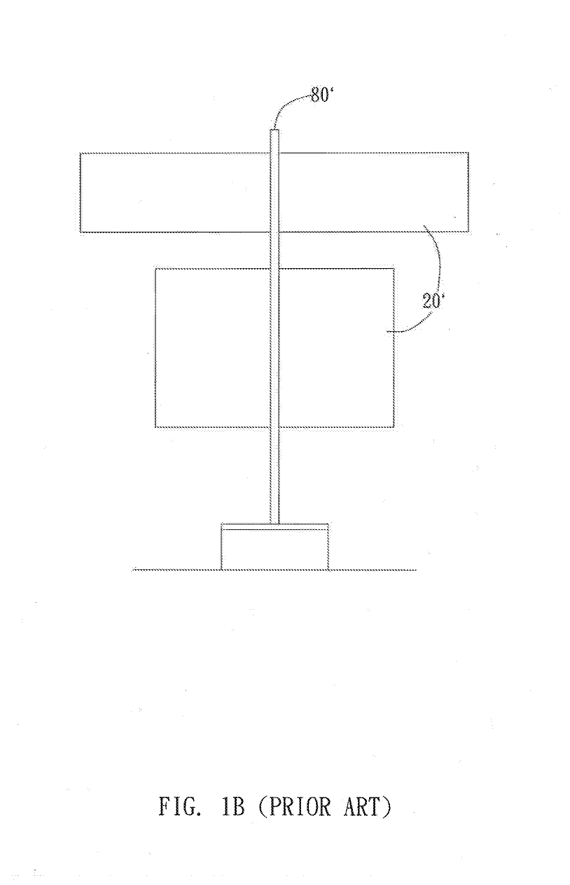

### DETAILED DESCRIPTION OF THE PREFERRED EMBODIMENT

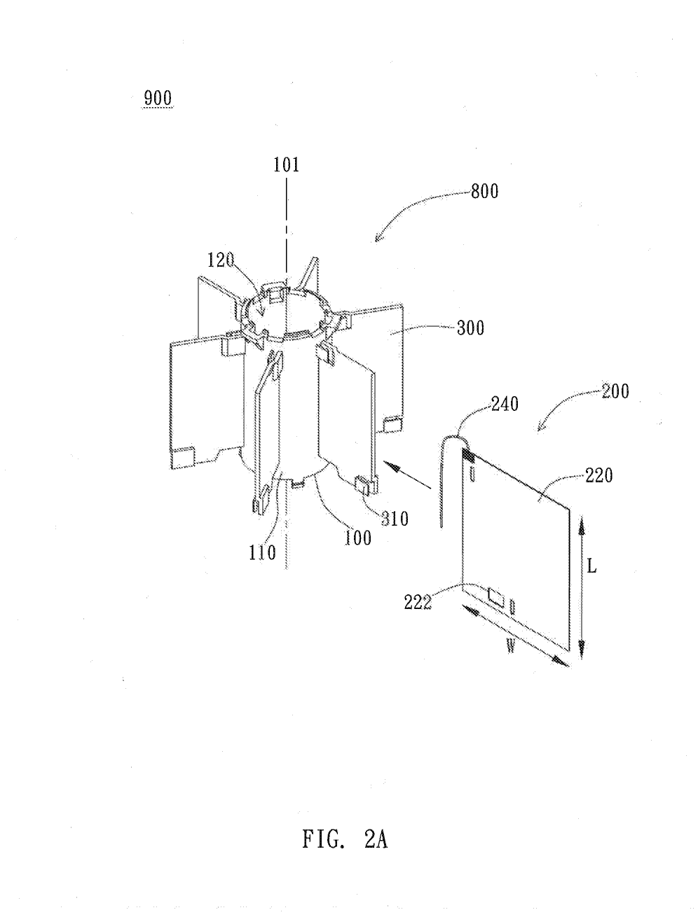

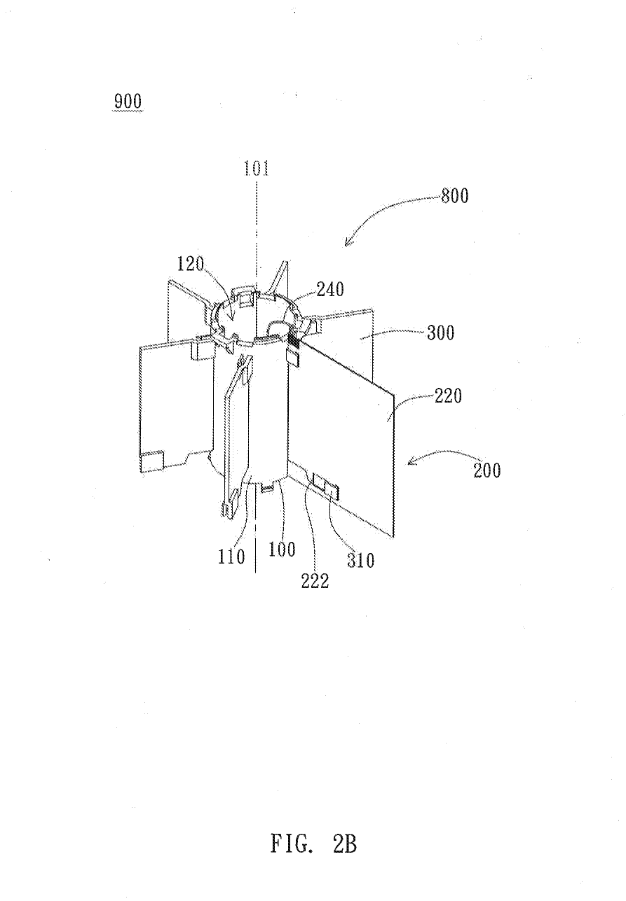

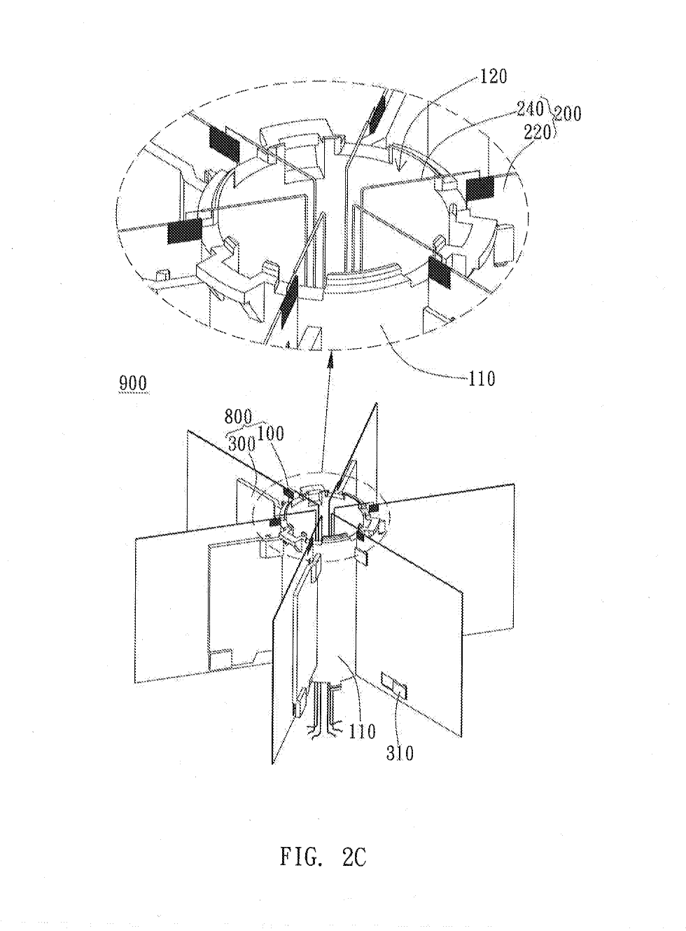

As the preferred embodiment shown in FIGS. 2A to 2C, the antenna support 800 of the present invention is for supporting the antenna unit 200. The antenna unit 200 and the antenna support 800 together form the antenna device 900. In other words, the antenna device 900 of the present invention includes the antenna unit 200 and the antenna support 800.

The antenna support 800 includes a tube-shaped support 100 and at least one antenna fixing unit 300. The tube-shaped support 100 is a hollow tube having an outer wall and forms an inner space 120. The tube-shaped support 100 may have at least one opening at one or two ends to communicate with the inner space 120. The tube-shaped support 100 is preferably made by Injection molding of polymer for decreasing the material cost and the manufacturing cost and reducing the interference with signal transmitting/receiving of the antenna unit 200. In other embodiments, however, the antenna support 100 could be made of metal or material other than polymer for having better rigidity. The antenna fixing unit 300 is disposed on the outer wall 110 of the tube-shaped support 100 for fixing the antenna unit 200. Accordingly, the antenna unit 200 can be supported by the antenna support 800.

The antenna unit 200 is for signal transmitting/receiving and is preferably but not limited to a plate. More particularly, as the preferred embodiments shown in FIGS. 2A to 2C, the antenna unit 200 has an antenna plate 220 and a wire 240 coupled to the antenna plate 220. The wire 240 is disposed in the inner space 120 of the tube-shaped support 100. The antenna plate 220 is fixed by the antenna fixing unit 300. As shown in FIGS. 2A and 2B, the antenna fixing unit 300 has an antenna fixing part 310 for fixing the antenna unit 200 on the antenna fixing unit 300. In the preferred embodiment, the antenna fixing part 310 is an elastic piece. The antenna plate 220 has a fixing hole 222 corresponding to the antenna fixing part 310, wherein the antenna fixing part 310 can be engaged with the fixing hole 222 (e.g. inserted into the fixing hole 222) for fixing the antenna plate 220 on the antenna fixing unit 300. This design is beneficial for installing and/or replacing the antenna plate 220 more easily. In other embodiment, however, the antenna unit 200 can be fixed on the antenna fixing unit 300 by other ways such as sticking, hitching, screwing, or welding.

In the preferred embodiment, the antenna fixing unit 300 is parallel to the axis 101 of the tube-shaped support 100 and extends outward from the outer wall 110 of the tube-shaped support 100. Since the antenna unit 200 is a plate, the antenna unit 200 is parallel to the axis 101 of the tube-shaped support 100 and is substantially perpendicular to the outer wall 110 of the tube-shaped support 100 when the antenna unit 200 is fixed on the antenna fixing unit 300. In other words, the antenna 220 extends outward along the radial direction of the tube-shaped support 100. Accordingly, even if the antenna plate 220 has larger length L and width W, it can be well installed without interference with adjacent antenna plate 220. Hence, the design and selection of the antenna plate 220 are more flexible,.

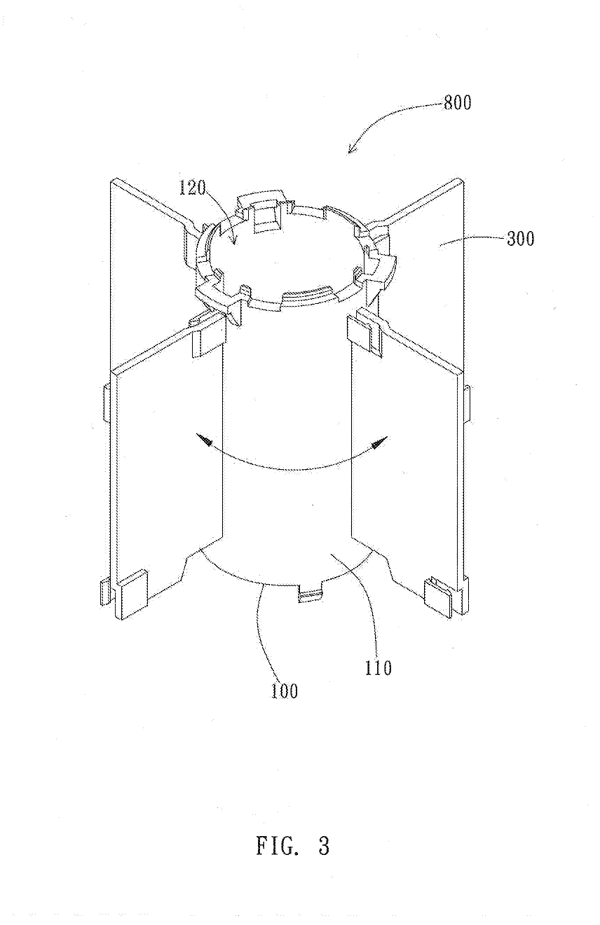

In other embodiments, regarding to demands such as reducing the weight and decreasing the material cost, the antenna fixing unit 300 can be a frame parallel to the axis 101 of the tube-shaped support 100 and extending outward form the outer wall of the tube-shaped support 100 or can be a slot parallel to the axis 101 of the tube-shaped support 100. On the other hand, as the preferred embodiments shown in FIGS. 2A to 2C, taking the balance in to consideration, the antenna fixing units 300 are disposed in pairs on opposite sides of the outer wall 110 of the tube-shaped support 100 with respect to the axis 101 of the tube-shaped support 100. More particularly, in the preferred embodiment, six antenna fixing units 300 are uniformly disposed on the outer wall 110 of the tube-shaped support 100 with an angle of 60° therebetween. In other embodiments, the number and arrangement of the antenna fixing unit 300 can be changed in accordance with the demand. In the embodiment shown in FIG. 3, If the antenna unit 200 (see FIGS. 2A-2C) to be supported is less than or equal to four, for reducing the weight and decreasing the material cost, there can be four antenna fixing units 300 uniformly disposed on the outer wall 110 of the tube-shaped support 100 with 90° angle between the adjacent ones. Taking a different point of view, since the antenna unit 200 is fixed on the antenna fixing unit 300, the installing angle of the antenna unit 200 can be determined by the antenna fixing unit 300. In other words, the installing angle of the antenna unit 200 can be changed by changing the installing angle of the antenna fixing unit 300 when manufacturing the antenna support 800.

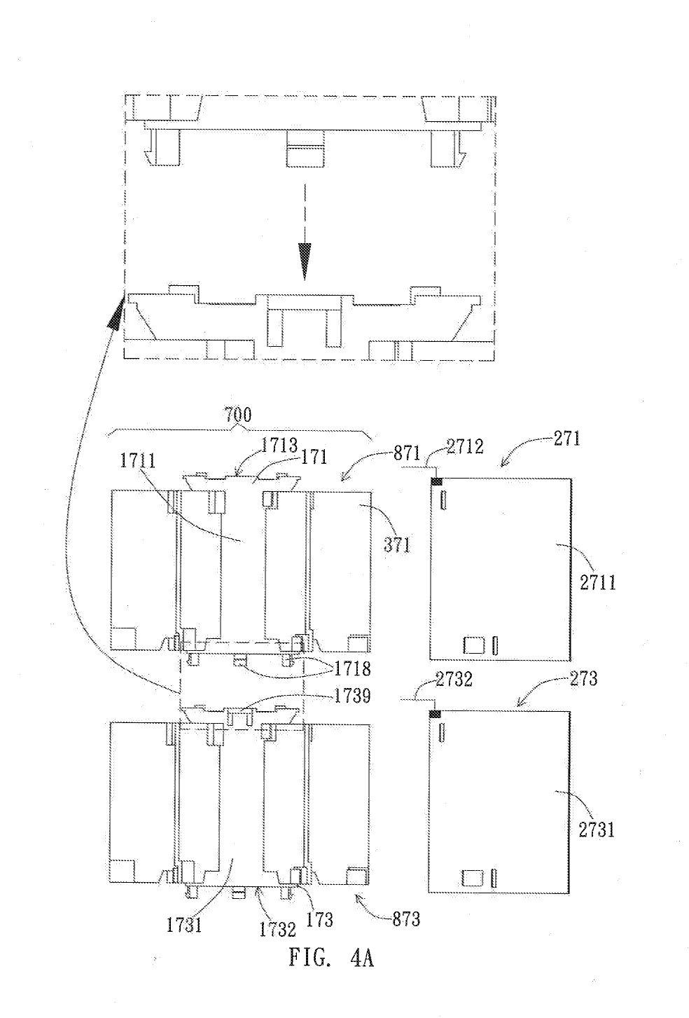

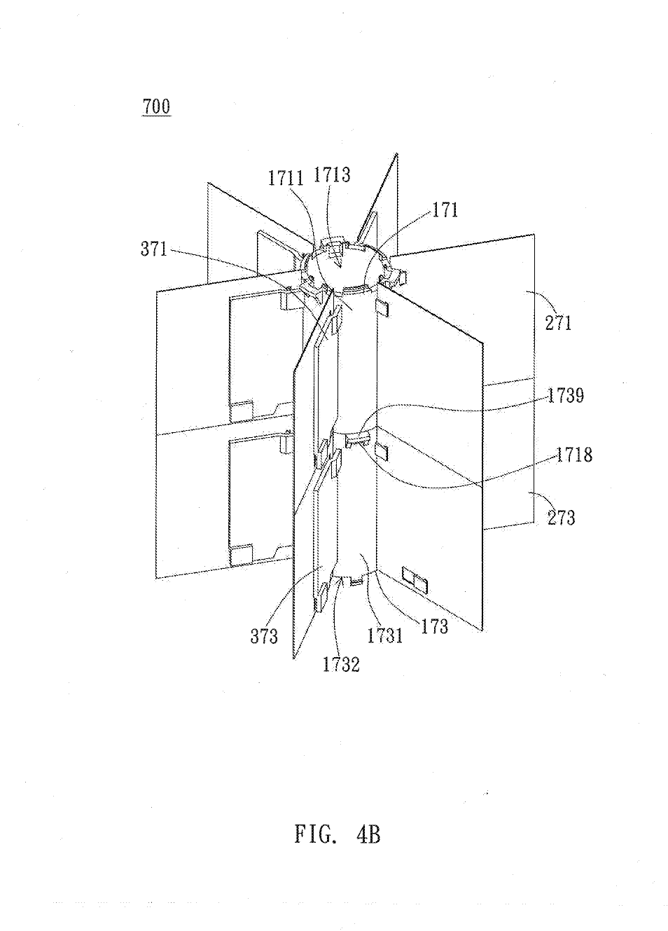

The tube-shaped support 100 further includes an engagement part disposed on the other end of the tube-shaped support for engaging with the tube-shaped support of another antenna support. In other words, a plurality of antenna support can engage with each other by the engagement part disposed on one end of the tube-shaped support to form the antenna support assembly. As the embodiments shown in FIGS. 4A and 4B, the antenna support assembly 700 supports the first antenna unit 271 and the second antenna unit 273. The antenna support assembly 700 includes a first antenna support 871 and a second antenna support 873. The first antenna support 871 includes a first tube-shaped support 171 and at least one first antenna fixing unit 371 disposed on the outer wall 1711 of the first tube-shaped support 171 for fixing the first antenna unit 271. The second antenna support 873 includes a second tube-shaped support 173 and at least one second antenna fixing unit 373 disposed on the outer wall 1731 of the second tube-shaped support 173 for fixing the second antenna unit 273, wherein one end of the second tube-shaped support 173 engages with one end of the first tube-shaped support 171.

More particularly, as the embodiments shown in FIGS. 4A and 4B, the first antenna unit 271 has a first antenna plate 2711 and a first wire 2712 coupled to the first antenna plate 2711. The second antenna unit 273 has a second antenna plate 2731 and a second wire 2732 coupled to the second antenna plate 2731. The first wire 2712 is disposed in the inner space 1713 of the first tube-shaped support 171. The first antenna plate 2711 is fixed by the first antenna fixing unit 371. The second wire 2732 is disposed in the inner space 1732 of the second tube-shaped support 173. The second antenna plate 2731 is fixed by the second antenna fixing unit 373. Besides, the inner space 1713 and the inner space 1732 are preferably interlinked for the first wire 2712 as well as the second wire 2732 to be disposed in both the inner space 1713 and the inner space 1732. The first tube-shaped support 171 further includes a first engagement part 1718 disposed on one end of the first tube-shaped support 171; the second tube-shaped support 173 further includes a second engagement part 1739 disposed on one end of the second tube-shaped support 173. The first engagement part 1718 and the second engagement part 1739 are respectively hook and buckle to be engaged with each other.

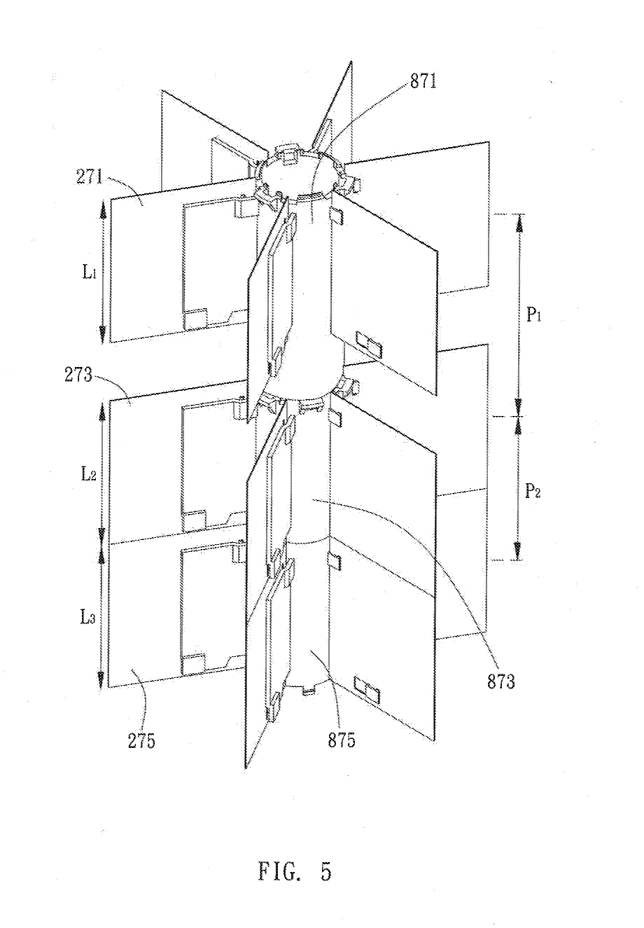

More particularly, different antenna supports can be connected to each other to form an antenna support assembly, wherein different antenna units can be supported by a single antenna support assembly to reduce the space occupied by antenna supports required for individual antenna units and to make the design more flexible. As the embodiment shown in FIG. 5, the antenna support assembly 700 includes a first antenna support 871, a second antenna 873, and a third antenna support 875 for respectively supporting a first antenna unit 271 having length L₁, a second antenna unit 273 having length L₂, and a third antenna unit 275 having length L₃. All of L₁, L₂ and L₃ are equal shown in FIG. 5. But all of them can be adjusted in different lengths as long as adjusting the length of 373 (FIG. 4B) and 871 (FIG. 5) as described after several loines. In this embodiment, if the shorter first antenna unit 271 needs to be transferred to the position between the longer second antenna unit 273 and the third antenna unit 275 for reasons such as increasing the signal transmitting/receiving ability, it can be done by merely transferring the first antenna support 871 to the position between the second antenna support 737 and the third antenna support 875. Taking a different point of view, the distance between the antenna units can be adjusted by adjusting the length of the antenna support and/or the installing position of the antenna unit on the antenna support. In this embodiment, for example, the length of the first antenna support 871 is larger than those of the second antenna support 873 and the third antenna support 875, wherein the first antenna unit 271 is disposed in a higher position of the first antenna support 871. Therefore, the distance P₁ between the center of the first antenna unit 271 and the center of the second antenna unit 273 is larger than the distance P₂ between the center of the second antenna unit 273 and the center of the third antenna unit 275.

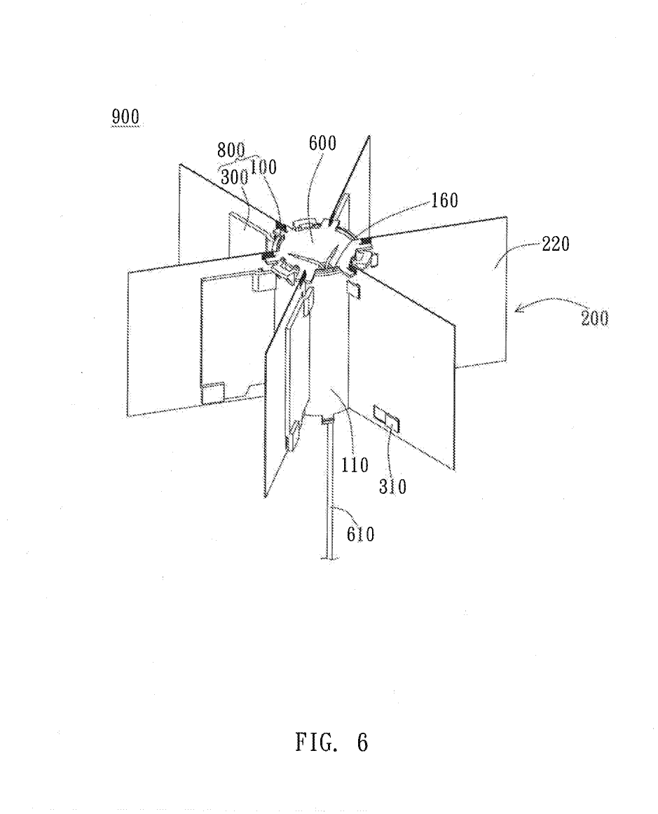

As the embodiment shown in FIG. 6, the antenna device 900 further includes a circuit board 600 disposed at one and of the tube-shaped support 100, wherein the end of the tube-shaped support 100 has a circuit board engagement part 160 for fixing the circuit board 600. More particularly, the circuit board 600 is preferably a Switch Printed Circuit Board Assembly. The antenna plate 220 of each antenna unit 200 can be directly coupled to the circuit board 600, wherein the circuit board 600 is coupled to the antenna wire 610. Accordingly, it is unnecessary to couple each antenna plate 200 to a main station respectively by the wire 210 (FIG. 2C).

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An antenna support for supporting an antenna unit, comprising:
a tube-shaped support; and
at least one antenna fixing unit disposed on an outer wall of the tube-shaped support for fixing the antenna unit.

2. The antenna support of claim 1, wherein the antenna unit has an antenna plate and a wire coupled to the antenna plate, the wire is disposed in an inner space of the tube-shaped support, the antenna plate is fixed by the antenna fixing unit.

3. The antenna support of claim 1, wherein the antenna fixing unit has an antenna fixing part for fixing the antenna unit on the antenna fixing unit.

4. The antenna support of claim 1, wherein the antenna unit is parallel to an axis of the tube-shaped support and is substantially perpendicular to the outer wall of the tube-shaped support when the antenna unit is fixed by the antenna fixing unit.

5. The antenna support of claim 1, wherein the antenna fixing unit is a plate parallel to an axis of the tube-shaped support and extending outward from the outer wall of the tube-shaped support.

6. The antenna support of claim 1, wherein the at least one antenna fixing unit includes a plurality of antenna fixing units disposed in pairs on opposite sides of the outer wall of the tube-shaped support with respect to an axis of the tube-shaped support.

7. The antenna support of claim 1, wherein the tube-shaped support further includes an engagement part disposed on an end of the tube-shaped support for engaging with the tube-shaped support of another antenna support.

8. An antenna device, comprising:
an antenna unit; and
an antenna support for supporting the antenna unit, the antenna support comprising:
a tube-shaped support; and
at least one antenna fixing unit disposed on an outer wall of the tube-shaped support for fixing the antenna unit.

9. The antenna device of claim 8, further comprising a circuit board disposed at an end of the tube-shaped support.

10. The antenna device of claim 9, wherein the end of the tube-shaped support has a circuit board engagement part for fixing the circuit board.

11. An antenna support assembly for supporting a first antenna unit and a second antenna unit, the antenna support assembly comprising:
a first antenna support, including:
a first tube-shaped support; and
at least one first antenna fixing unit disposed on an outer wall of the first tube-shaped support for fixing the first antenna unit; and
a second antenna support, including:
a second tube-shaped support, wherein one end of the second tube-shaped support engages with one end of the first tube-shaped support; and
at least one second antenna fixing unit disposed on an outer wall of the second tube-shaped support for fixing the second antenna unit.

12. The antenna support assembly of claim 11, wherein the first antenna unit has a first antenna plate and a first wire coupled to the first antenna plate, the second antenna unit has a second antenna plate and a second wire coupled to the second antenna plate, the first wire is disposed in an inner space of the first tube-shaped support, the first antenna plate is fixed by the first antenna fixing unit, the second wire is disposed in an inner space of the second tube-shaped support, the second antenna plate is fixed by the second antenna fixing unit.

13. The antenna support assembly of claim 11, wherein the first tube-shaped support further includes a first engagement part disposed on the one end of the first tube-shaped support, the second tube-shaped support further includes a second engagement part disposed on the one end of the second tube-shaped support, the first engagement part and the second engagement part engage with each other.

14. The antenna support assembly of claim 11, wherein the first antenna support and the second antenna support are identical.

15. The antenna support assembly of claim 11, wherein the first antenna support and the second antenna support are different.
